(19) United States
(12) Patent Application Publication
(10) Pub. No.: US 2009/0279007 A1
(43) Pub. Date: Nov. 12, 2009

(54) LIQUID CRYSTAL DISPLAY

(75) Inventors: Po-Sheng Shih, Hsinchu City (TW); Jiunn-Shyong Lin, Changhua City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HANNSTAR DISPLAY CORPORATION, Taipei County (TW)

(21) Appl. No.: 12/338,038

(22) Filed: Dec. 18, 2008

(30) Foreign Application Priority Data
May 7, 2008 (TW) 097116907

(51) Int. Cl. G02F 1/133

(52) U.S. Cl. 349/37; 349/38

(57) ABSTRACT

A liquid crystal display (LCD) is provided. The liquid crystal display includes a first and a second scan lines and a first and a second data lines crossing each other for defining a first pixel having a first and a second switches and a second pixel having a third switch; a first, a second and a third storage capacitors, each of which has a first and a second electrodes; and a conducting line, coupled to the second electrodes of the first, the second and the third storage capacitors.

### FIELD OF THE INVENTION

The present invention relates to a liquid crystal display, and more particularly to a thin-film transistor liquid crystal display (TFT LCD).

### BACKGROUND OF THE INVENTION

Current high-resolution color monitors, for their low power consumption, are widely used for various electronic facilities. To look for a wider view angle, Fujitsu has developed the Multi-domain Vertical Alignment (MVA) technology that may achieve a maximum viewing angle of 178 degrees while keeping a higher contrast than that of the other wide viewing angle techniques.

It is well known that the MVA is a technique of optical compensation for liquid crystal displays. It is mainly a multi-domain method of dividing a pixel into four portions (domains) and differentiating the inclination of each domain element, to result in a homogenization of viewing angle dependence as well as to resolve the variation of hue from different directions. Unfortunately, the use of MVA methodology could end up with color washout for both skin color and sky color when viewing from an oblique angle.

FIG. 1 shows a transmission-voltage diagram of a liquid crystal molecule using MVA technology. The horizontal axis indicates the gray level voltage of the liquid crystal molecule with a unit of volt (V), and the vertical axis indicates the transmittance. A dotted line 101 shows a first transmission-voltage curve when observing normal to the liquid crystal display, while a dotted line 102 shows a second transmission-voltage curve when observing from a deflective direction. Comparing the two curves in a region 100, the line 102 does not behave the same as the line 101 where an increase of transmission is proportional to an increase of voltage. In other words, the change of transmission is not proportional to the change of an offset voltage along the line 102 in the region 100, which is the main reason for color shift.

Consequently, one solution for the above-mentioned deficiency of color shift has been raised, which is mainly to divide a pixel into eight portions (8 domains, 4 azimuthal×2 polar angle). All these domains are adjusted according to some horizontal common electrodes and vertical sub-pixel electrodes. More in detail, according to FIG. 2A, a common electrode 201 includes a first vertical portion 201a, a second vertical portion 201b, and a first horizontal portion 201c; while a sub-pixel electrode 202 includes a first horizontal portion 202a and a vertical portion 202b. Two liquid crystal modules 400 are at an initial status when no voltage is applied to the common electrode 201 and the sub-pixel electrode 202.

As shown in FIG. 2B, a first electric field 300a and a second electric field 300b are produced when an external voltage is applied to the common electrode 201, and the sub-pixel electrode 202. As a result, the liquid crystal modules 400 rotate along the first electric field 300a and the second electric field 300b respectively. With the increase of the voltage, each of the liquid crystal modules 400 moves toward a direction that is the same as the axis of the electrode field nearby. However, when the first electric field 300a and the first horizontal portion 202a of the sub-pixel electrode 202 produce an angle of 135 degrees and when the second electric field 300b and the first vertical portion 202b of the sub-pixel electrode produce an angle of 45 degrees, the liquid crystal modules 400 re-align respectively. For this particular result, it is observed that the application of high voltage will not cause a decrease of transmission.

The US Patent Application No. 20050122441 of Sharp adopts the 8-domain technology. FIG. 3 shows an equivalent circuit diagram of a pixel 50 of the conventional liquid crystal display. The pixel 50 (either R pixel, G pixel, or B pixel) could comprise two sub-pixels. A first sub-pixel 51 and a second sub-pixel 52 respectively contain their own thin-film transistor (TFT) 511 and thin-film transistor 512, sub-pixel electrodes 513 and 514 connected to TFTs 511 and 512 respectively, storage capacitors 515 and 516 connected to the sub-pixel electrodes 513 and 514 respectively, liquid crystal capacitors 517 and 518 respectively connected to the sub-pixel electrodes 513 and 514 while parallel to the storage capacitors 515 and 516, and counter electrodes (or, common electrode Vcom) 519 and 520 respectively connected to the liquid crystal capacitors 517 and 518. As shown in FIG. 3, gates of the TFTs 511 and 512 are connected to a common scan line (gate bus line) 530 and turned on and off by a common scan signal, and sources are connected to a data line 531. One end of the storage capacitors 515 and 516 is respectively connected to the TFTs 511 and 512 via the sub-pixel electrode 513 and 514, and the other end of the storage capacitors 515 and 516 is respectively connected to storage capacitor lines 532 and 533 via counter electrodes of the storage capacitors. The storage capacitors receive different storage capacitor counter voltages respectively via the storage capacitor lines 532 and 533.

The function of the above-mentioned TFTs is a switch, which relies on a gate driver (not shown) scanning each scan line in a sequence to turn on the scan lines from upper to lower levels in order. At the time when a full row of TFTs are turned on, a source driver (not shown) writes in the signal voltage. The storage capacitors 515 and 516 and the liquid crystal capacitors 517 and 518 are connected in parallel to increase the capacity for maintaining the signal voltage. The source driver is extremely important to the display of high-speed driving, high resolution, and low power consumption. In addition, the color on the display panel is created by applying a signal voltage from the outside to change the transmission of the liquid crystals where lights from the backside illumination pass through. Lights of different brightness pass the color-filtering layer and turn into signals of R, G or B that constitute a color. To avoid the electro-chemical reaction on the electrode surface of an LCD panel that results in lifetime shortage of the LCD devices, the prior art developed by Sharp adopts the method of dot inversion to make the driving voltage of the LCD perform polarity inversion periodically. The embodiment is described below.

Please refer to FIG. 4, which describes the circuit of the Sharp LCD that adopts dot inversion, wherein a pixel is represented by a matrix of 8 rows and 6 columns; the data lines are represented by S-C1, S-C2, S-C3, . . . , and S-Ccq; the scan lines are represented by G-L1, G-L2, G-L3, . . . , and G-Lrp; the storage capacitor lines are represented by CS-A and CS-B. It is to be noticed in FIG. 4 that a voltage of a sub-pixel electrode higher than that of a counter electrode has a positive polarity (marked by a “+” sign), while a voltage of a sub-pixel electrode lower than that of a counter electrode has a negative polarity (marked by a “−” sign). It is well-known that adopting dot inversion could make a polarity difference between two adjacent points and thereby reduce the occurrence of cross-talk effect.

Please refer to FIG. 5, which is an equivalent circuit diagram according to a certain area of the Sharp LCD, wherein each of the pixels has two sub-pixels (indicated by symbols A and B). Each sub-pixel comprises a liquid crystal capacitor CLA_n,m or CLB_n,m as well as a storage capacitor CCSA_n,m or CCSB_n,m. Each liquid crystal capacitor is composed of a sub-pixel electrode, a counter electrode ComLC, and a liquid crystal layer sandwiched therebetween. Each storage capacitor is composed of a storage capacitor electrode, an insulating film, and storage capacitor counter electrodes (ComCSA_n and ComCSB_n). The two sub-pixels are connected to a common source bus line SBL_m via their own thin-film transistors TFTA_n,m and TFTB_n,m respectively. The TFTA_n,m and the TFTB_n,m are turned on and off by a scanning signal voltage supplied to a common scanning line (gate bus line) GBL_n. When the two TFTs are turned on, display signal voltages are supplied to the respective sub-pixel electrodes and storage capacitor electrodes of the two sub-pixels via a common data line. Via a CS bus line (CSBL), the storage capacitor counter electrode of one of the two sub-pixels is connected to a storage capacitor trunk (CS trunk) CSV-typeR1, and the storage capacitor counter electrode of the other sub-pixel is connected to a storage capacitor trunk (CS trunk) CSVtypeR2.

Please refer to FIG. 6, which shows the voltage waveforms (a)-(j) according to the pixel circuit layout of FIG. 4.

The waveform (a) is display signal voltage waveforms (source signal voltage waveforms) supplied to the data lines S-C1, S-C3, S-C5, . . . (odd numbered group, SO). The waveform (b) is display signal voltage waveforms supplied to the data lines S-C2, S-C4, S-C6, . . . (even numbered group, SE). The waveform (c) is a storage capacitor counter voltage waveform supplied to the storage capacitor line CS-A. The waveform (d) is a storage capacitor counter voltage waveform supplied to CS-B. When voltages are supplied to the scanning lines G-L1˜G-L6, the corresponding scan voltage waveforms (e)˜O) are shown. Therefore, when a gate driver turns on a row of the TFT switches through the scanning lines G-1˜G6, a source driver timely inputs a signal voltage corresponding to the pixel, to provide the display signal.

As shown in FIG. 6, the period between the time when the voltage of a scan line changes from a low level (VgL) to a high level (VgH) and the time when the voltage of the next scan line changes from VgL to VgH constitutes one horizontal scanning period (1 H). The period during which the voltage of a scan line remains at a high level (VgH) is sometimes referred to as a selection period PS. Since all pixels are displaying an intermediate grayscale, all display signal voltages (waveforms (a) and (b)) have oscillating waveforms of fixed amplitude. Also, the oscillation period of the display signal voltages is two: horizontal scanning periods (2 H). However, the capacitor charging time on the pixel driving circuit becomes considerably crucial and important, when a TFT LCD including the above-mentioned Sharp LCD needs to achieve the purpose of large scale and high resolution. Since the resolution is to be escalated, the number of scanning lines must be increased. The more numbers of scanning are to be completed in one constant period of time, the shorter period of time is allowed for each scanning. For a large-scale liquid crystal panel, the relevant storage capacitors become larger accordingly.

Unfortunately, due to the reason of RC-delay (the C indicates the capacitance of the storage capacitor lines CS-A and CS-B, while the R indicates the resistance of CS-A and CS-B), the capacitors cannot be charged efficiently which results in a longer charging time (τ) when the Sharp LCD doubles its scanning speed to a 120 Hz operation mode. Please refer to FIG. 7, which is an actual voltage waveform of the storage capacitor lines CS-A and CS-B, wherein the RC-delay is around 5 microseconds. It is to be noted that a voltage waveform collected from the CS-B changes from V1 to V2 after RC-delay, which results in a difference of pixel voltage between the center of the panel and the edge thereof. Besides, the pixel circuit of the Sharp LCD has two capacitor trunks, which results in a significant RC-delay effect.

According to the above, it is urgently required to provide a high-resolution liquid crystal display.

### SUMMARY OF THE INVENTION

In accordance with one aspect of the present invention, a high-resolution liquid crystal display is provided wherein each of the R, G and B pixels are divided into two sub-pixels. Unlike the conventional LCD without an efficient charging operation due to the effect of RC-delay, the present invention takes advantage of dividing a pixel into two sub-pixels, each comprising thin-film transistors, liquid crystal capacitors, and storage capacitors, wherein at least one of the storage capacitors is a variable capacitor. After a high voltage is provided to the scanning lines to turn on the transistors in sequence, a data signal is provided to a data line and a control signal is provided to a conducting line connected to each of the storage capacitors respectively. When a voltage of the scanning line shifts from high level to low level, the sub-pixel and its adjacent sub-pixel respectively produce corresponding voltage variations of a first sub-pixel and a second sub-pixel and adjust either the value of the storage capacitor or the value of the crystal capacitor of the sub-pixels, to bring a different degree of voltage variations for the signal voltages between two adjacent frame periods.

In accordance with another aspect of the present invention, a pixel circuit of a liquid crystal display is provided. In the present invention, a pixel containing two TFTs is connected to an adjacent pixel containing two reversely located TFTs via a conducting line (CS). Compared to the Sharp LCD in the prior art whose storage capacitor needs two conducting lines (CS), the present invention has the advantages of simplifying the production process, reducing the cost, increasing the aperture ratio, and improving the yield rate.

In accordance with a further aspect of the present invention, a driving method for a liquid crystal display is provided, which adopts a row-inversion driver (signal driver) to allow a characteristic of dot inversion for the display.

In accordance with further another aspect of the present invention, a liquid crystal display (LCD) is provided. The LCD includes a first and a second scan lines and a first and a second data lines crossing each other for defining a first pixel having a first and a second switches and a second pixel having at least a third switch. The LCD also includes a first, a second and a third storage capacitors, each of which has a first and a second electrodes, and a conducting line, coupled to the second electrodes of the first, the second and the third storage capacitors.

Preferably, each of the first, the second and the third switches has a drain, a gate and a source.

Preferably, the drains of each of the first, the second and the third switches are coupled to the first electrodes of the first, the second and the third storage capacitors respectively.

Preferably, the gates of the first and the second switches are coupled to the first scan line, the gate of the third switch is coupled to the second scan line, the sources of the first and the second switches are coupled to the first data line, and the source of the third switch is coupled to the second data line.

Preferably, provided a control signal to the conducting line, provided the data signal to the first data line, and the control signal and the data signal have a same frequency.

Preferably, the control signal is a variable voltage.

Preferably, the conducting line is located between the first and the second scan lines.

Preferably, the first and the second storage capacitors have different capacity values, and at least one of the first and the second storage capacitors is a variable capacitor.

Preferably, the LCD further includes a common electrode and a first and a second liquid crystal capacitors having a respective third electrode.

Preferably, the drains of the first and the second switches are coupled to the first and the second liquid crystal capacitors respectively.

Preferably, at least one selected from a group consisting of the first and the second storage capacitors and the first and the second liquid crystal capacitors has a capacity value different from those of the others.

Preferably, the third electrodes of the first and the second liquid crystal capacitors are coupled to the common electrode, which is configured to receive a common voltage signal being a constant voltage.

Preferably, the LCD further includes a first, a second and a third sub-pixel electrodes respectively coupled to the first, the second and the third storage capacitors.

Preferably, the third switch is turned on at a different time when the first and the second switches are turned on.

Preferably, the first and the second switches are turned on via the first scan line, a first signal is written into the first sub-pixel via the first data line, the third switch is turned on via the second scan line, a second signal is written into the third sub-pixel via the second data line, and the first signal has a polarity opposite to that of the second signal.

Preferably, the first and the second switches are turned on via the first scan line, a data signal is transmitted to the first pixel via the first data line, and the first capacitor has a capacity value different from that of the second capacitor.

Preferably, the LCD further includes a first and a second sub-pixel electrodes coupled to the first electrodes of the first and the second storage capacitors respectively.

Preferably, the first and the second pixel electrodes have different voltage variations by means of inputting data signals to the first and the second pixel electrodes.

Preferably, the LCD further includes a first and a second sub-pixel electrodes coupled to the first electrodes of the first and the second storage capacitors respectively.

Preferably, the first and the second switches are turned on via the first scan line, and the first and the second pixel electrodes have different voltage variations by means of inputting a data signal to the first pixel via the first data line.

In accordance with further another aspect of the present invention, a driving method for a liquid crystal display is provided. The driving method includes (a) coupling the, first and the second switches to the first electrodes of the first and the second storage capacitors respectively, and to the electrodes of the first and the second liquid crystal capacitors respectively; (b) coupling the second electrodes of the first and the second storage capacitors to the conducting line; (c) coupling the gates of the first and the second switches to the first scan line; (d) coupling the sources of the first and the second switches to the first data line, and at least one of the first and the second storage capacitors and the first and the second liquid crystal capacitors has a different capacity value from those of the others; (e) providing a first scanning signal to the first scan line to turn on the first and the second switches; and (f) providing a first data signal and a control signal to the first data line and the conducting line respectively, in which the first data signal and the control signal have a same frequency.

Preferably, the LCD comprises a first pixel, a conducting line, a first and a second storage capacitors, each of which comprises a first and a second electrodes, a first and a second liquid crystal capacitors having a respective third electrode, a first scan line and a first data line, and the first pixel comprises a first and a second switches each of which has a gate and a source.

Preferably, the LCD further includes a first and a second pixel electrodes coupled to the first electrodes of the first and the second storage capacitors respectively, the first and the second storage capacitors have different capacity values, and the control signal is a variable voltage. Preferably, the driving method further includes transmitting the first data signal to the first and the second pixel electrodes for differentiating voltage variations between the first and the second pixel electrodes.

Preferably, the LCD further includes a second pixel adjacent to the first pixel, a second scan line and a second data line, and the second pixel comprises a third switch having a gate and a source coupled to the second scan line and the second data line respectively and a third storage capacitor having a first electrode coupled to the conducting line.

Preferably, the driving method further includes providing a second scanning signal to the second scan line to turn on the third switch after providing the first scanning signal, and providing a second data signal to the second data line.

Preferably, the second data signal and the control signal have a same frequency, and the first and the second data signals have opposite polarities.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a transmission-voltage diagram of a liquid crystal molecule using MVA technology;

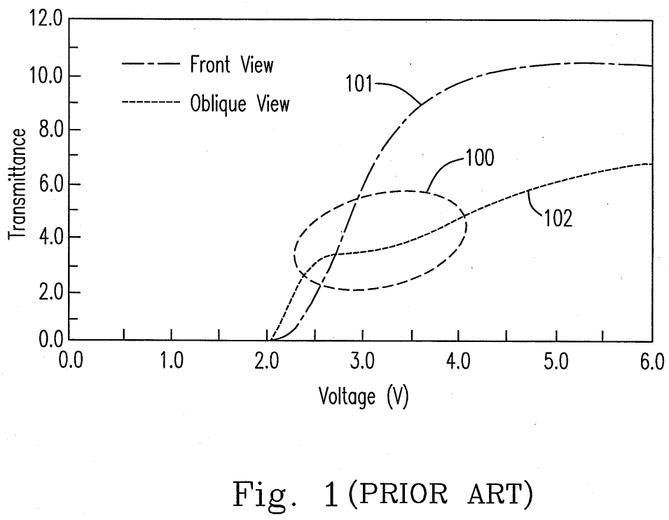

FIG. 2(a) is a schematic diagram showing a domain element without applying an external voltage thereto;

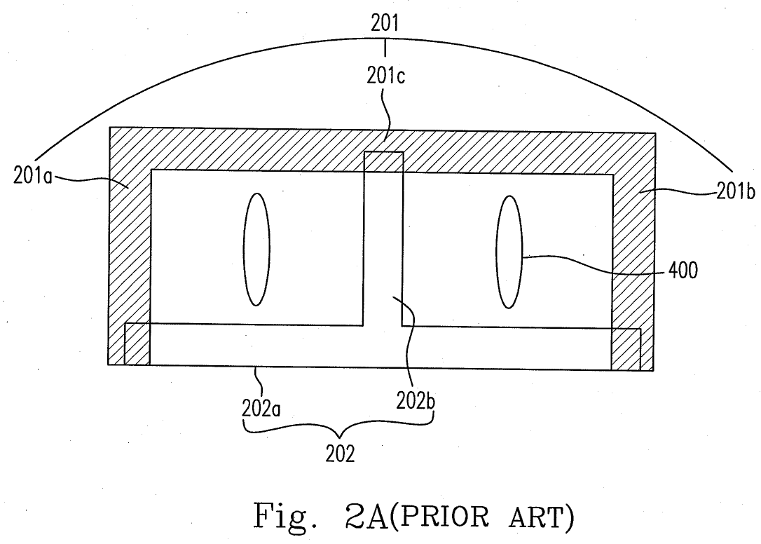

FIG. 2(b) is a schematic diagram showing a domain element when tn external voltage is applied thereto;

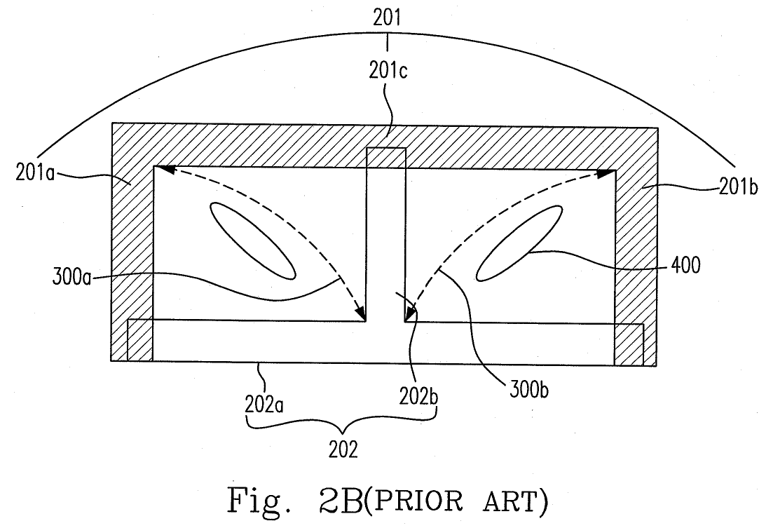

FIG. 3 is an equivalent circuit diagram of a pixel of a conventional liquid crystal display;

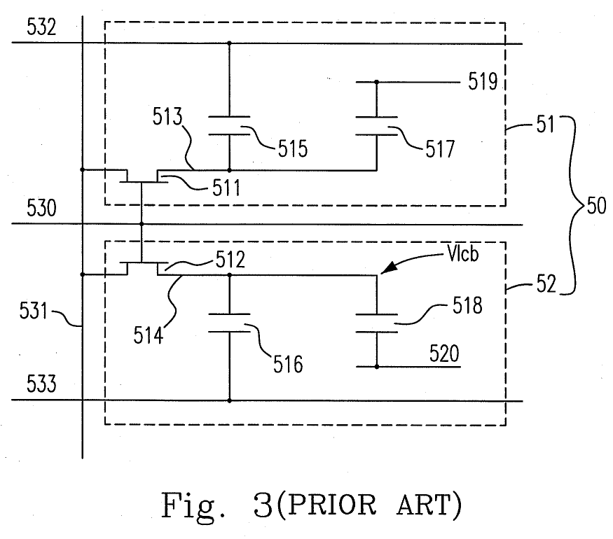

FIG. 4 is a schematic diagram showing the circuit of the Sharp CD that adopts the dot inversion technique;

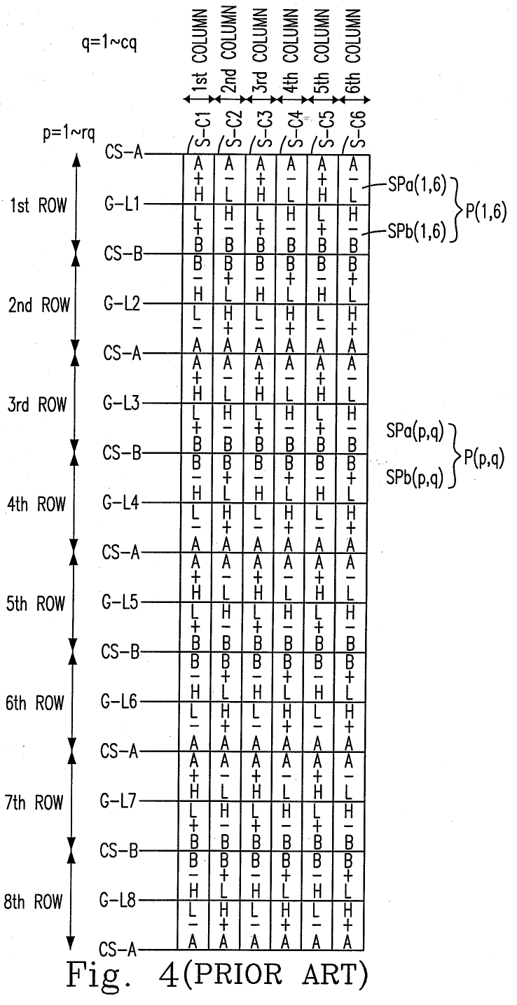

FIG. 5 is an equivalent circuit diagram according to a certain area of the Sharp LCD;

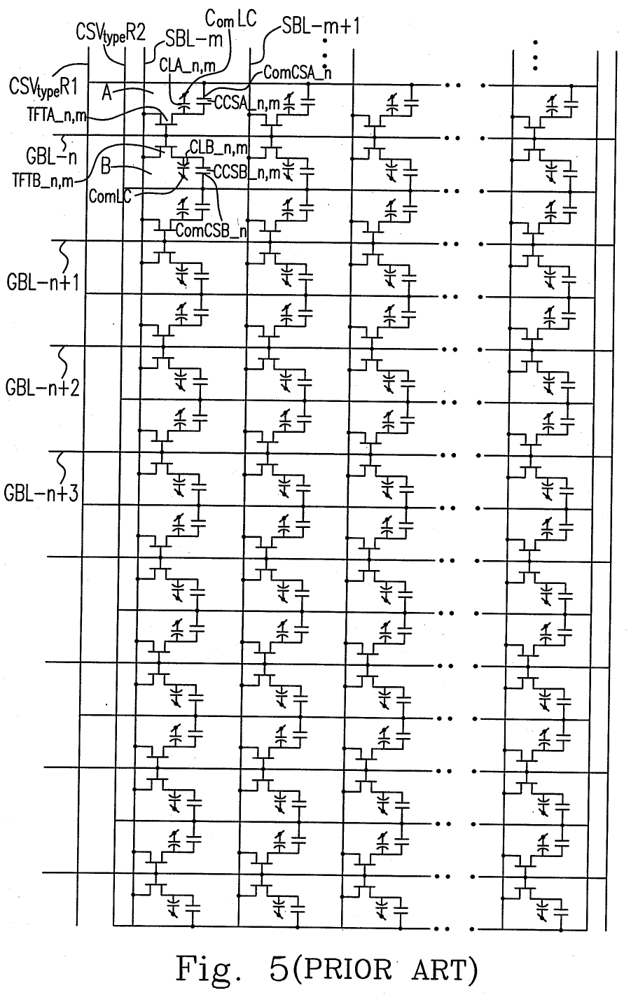

FIG. 6 shows the voltage waveforms (a)-(j) according to the pixel circuit layout of FIG. 4;

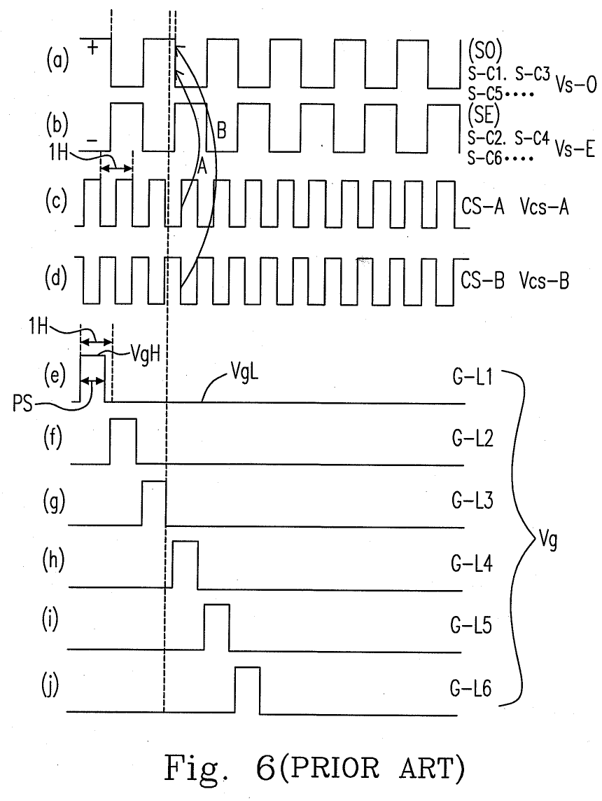

FIG. 7 is an actual voltage waveform of the storage capacitor lines CS-A and CS-B;

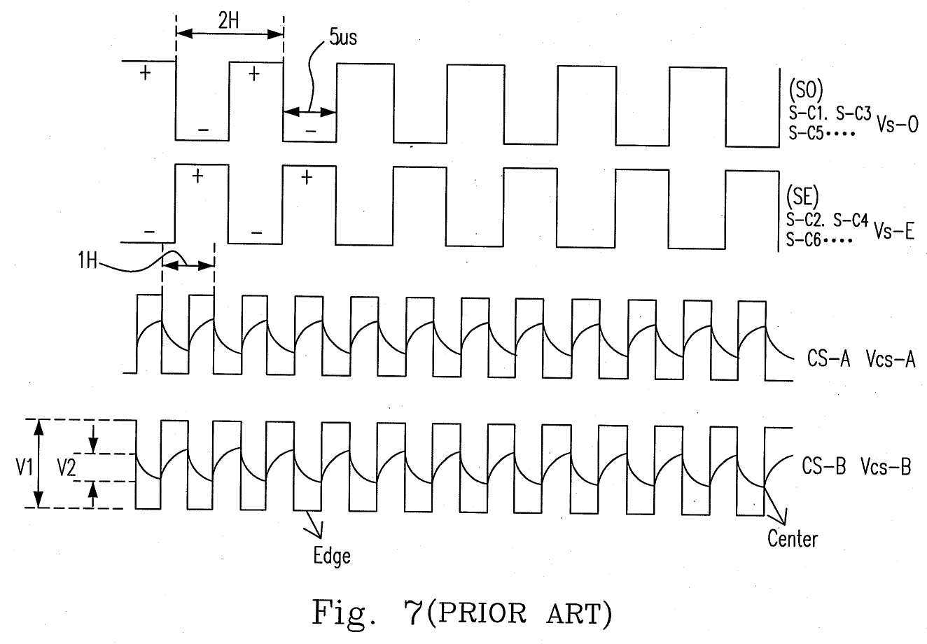

FIG. 8 is an equivalent circuit diagram according to a certain area of one embodiment of the present invention;

FIG. 9 shows the driving waveform diagram for driving pixel units in one preferred embodiment of the present invention;

FIG. 10 shows a voltage waveform of the storage capacitors along a conducting line;

FIG. 11 illustrates the relationship between the data sent out from the row-inversion driver and the scanning timing of each scan line as well as the patterns of the video signals from the data lines when the method of row-inversion is engaged in driving a thin-film LCD; and

FIG. 12 illustrates the video data when the LCD is driven by the row-inversion method.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

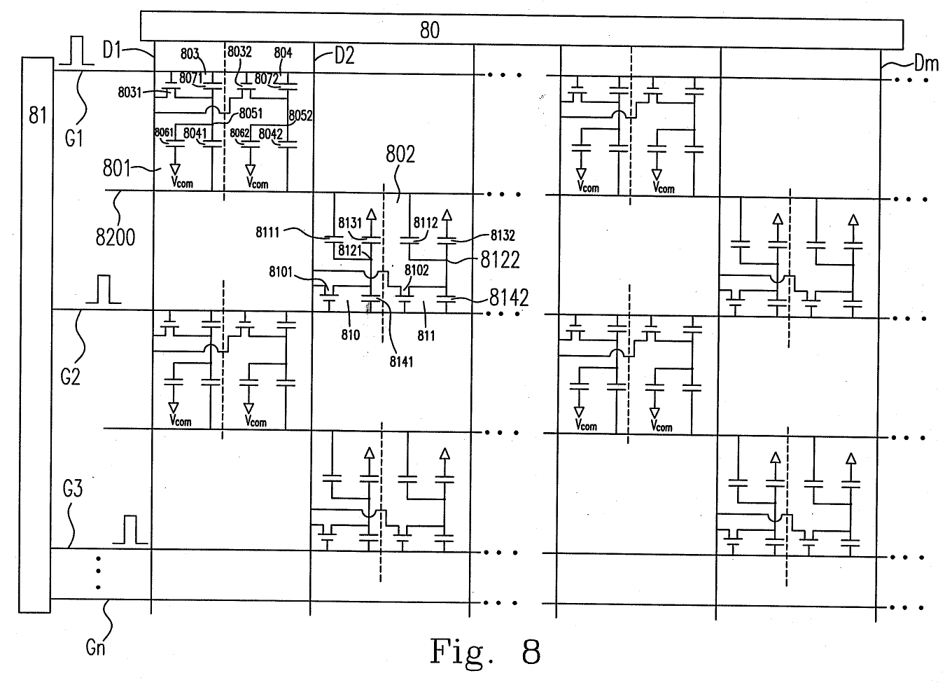

FIG. 8 is an equivalent circuit diagram according to a certain area of one embodiment of the present invention. The LCD chip adopted by the LCD panel circuit of the present invention includes two major types of IC, wherein one is a control IC (not shown) for transferring as well as processing image signals and for receiving signals from computers, and the other is a driver IC for outputting as well as displaying images and for outputting signals to LCD panels. The driver IC contains a source driver 80 and a gate driver 81. The selected number of both (80 and 81) for composing the driver IC depends on the desired resolution of the LCD.

Please refer to FIG. 8, wherein among a number of n scan lines (Gn) and a number of m data lines (Dm), a first and a second scan lines (G1 and G2) and a first and a second data lines (D1 and D2) cross each other for defining a first pixel 801 and a second pixel 802, wherein the first pixel 801 and the second pixel 802 each comprises two sub-pixels. In addition, in the first pixel 801, a first sub-pixel 803 and a second sub-pixel 804 each comprises thin-film transistor switches, a first switch 8031 and a second switch 8032. Drains of the first switch 8031 and the second switch 8032 are coupled to a first electrode of a first storage capacitor 8041 and a first electrode of a second storage capacitor 8042, respectively. Gates of the first switch 8031 and the second switch 8032 are coupled to the first scan line G1. Sources of the first switch 8031 and the second switch 8032 are coupled to the first data line D1. The first electrode of the first storage capacitor 8041 and the first electrode of the second storage capacitor 8042 are coupled to a first sub-pixel electrode 8051 and a second sub-pixel electrode 8052, respectively. The drains of the first switch 8031 and the second switch 8032 are coupled to a first liquid crystal capacitor 8061 and a second liquid crystal capacitor 8062, respectively. A first electrode of the first liquid crystal capacitor 8061 and a first electrode of the second liquid crystal capacitor 8062 are coupled to a first and a second common electrodes respectively, wherein the common electrodes have a voltage signal of Vcom. The drain and the gate of the first switch 8031 and those of the second switch 8032 respectively constitute a first parasitic capacitor 8071 and a second parasitic capacitor 8072, at an overlapping area between the drains and the gates therein.

Similarly, the second pixel 802 adjacent to the first pixel 801 comprises two sub-pixels (a third sub-pixel 810 and a fourth sub-pixel 811). The third sub-pixel 810 and the fourth sub-pixel 811 respectively comprise thin-film transistor switches, a third switch 8101 and a fourth switch 8102. To reduce a frequency of the voltage by half, the second pixel 802 is inversely connected to the first pixel 801. More details are described thereinafter.

Inside the second pixel 802, drains of a third switch 8101 and a fourth switch 8102 are respectively coupled to a first electrode of a third storage capacitor 8111 and a first electrode of a fourth storage capacitor 8112, gates of the third switch 8101 and the fourth switch 8102 are coupled to the second scan line G2, and sources of the third switch 8101 and the fourth switch 8102 are coupled to the second data line D2. The first electrode of the third storage capacitor 8111 and the first electrode of the fourth storage capacitor 8112 are respectively coupled to a third pixel electrode 8121 and a fourth pixel electrode 8122, the drains of the third switch 8101and the fourth switch 8102 are respectively coupled to a third liquid crystal capacitor 8131 and a fourth liquid crystal capacitor 8132, an electrode of the third liquid crystal capacitor 8131 and an electrode of the fourth liquid crystal capacitor 8132 are respectively coupled a third and a fourth common electrodes which have a voltage signal of Vcom. The drain and the gate of the third switch 8101 and those of the fourth switch 8102 respectively constitute a third parasitic capacitor 8141 and a fourth parasitic capacitor 8142, at an overlapping area between the drains and the gates therein.

To sustain a sufficient voltage in the storage capacitors of each pixel for the need of updating a next screen, the present invention provides a conducting line 8200 between the first pixel 801 and the second pixel 802 for receiving a variable voltage (i.e. a control signal). The conduction line 8200 is coupled to a second electrode of the first storage capacitor 8041, the second storage capacitor 8042, the third storage capacitor 8111 and the fourth storage capacitor 8112. According to a preferred embodiment of the present invention, it should be noticed that at least one selected from a group of the first storage capacitor 8041 and the second storage capacitor 8042 is a tunable capacitor, and the tunable capacitor has a characteristic of changing its own capacitance according to the voltage variation in the sub-pixel electrodes and the conducting lines.

With the same idea of panel driving in the prior art, a preferred embodiment of the present invention provides a gate driver that drives a high voltage up to a number of N scan lines, wherein a waveform turns on each row of thin-film transistors in sequence. At the time when the gate driver is in a scanning status, a source driver outputs a gradation voltage to a number of M data lines. In a nutshell, in the driving process of the preferred embodiment of the present invention, the gate driver 81 provides a first scanning signal to a first scan line G1 for turning on the first switch 8031 and the second switch 8032. The above-mentioned switches respectively charge/discharge the first pixel electrode 8051 and the second pixel electrode 8052. A difference between the gradation voltage written into those sub-pixel electrodes and the voltage in the common electrodes effectively controls the brightness of transmitted light. The source driver 80 provides a first data signal to the first pixel 801 via the first data line D1, and the capacitance of the first storage capacitor 8041 is different from that of the second storage capacitor 8042.

At the time when the first switch 8031 and the second switch 8032 are turned off, the gate driver 81 provides a second scanning signal to a second scan line G2 for turning on the third switch 8101 and the fourth switch 8102. The above-mentioned switches respectively charge/discharge the third pixel electrode 8121 and the fourth pixel electrode 8122. A difference between the gradation voltage written into those sub-pixel electrodes and the voltage in the common electrodes effectively controls the brightness of transmitted light. The source driver 80 provides a second data signal to the second pixel 802 via a second data line D2.

Therefore, the gate driver 81 firstly provides the first scanning signal to the first scan line G1 for turning on a first switch 8031 and a second switch 8032, and then provides the second scanning signal to the second scan line for turning on the third switch 8101 and the fourth switch 8102. In other words, the turn-on timing of the first switch 8031 and the second switch 8032 is different from that of the third switch 8101 and the fourth switch 8102, which allows the storage capacitors to be charged up to a predetermined voltage value via the conducting line 8200.

According to the embodiment of the present invention, a common voltage signal Vcom of a constant voltage value is applied to the common electrodes of each liquid crystal capacitor, to avoid destruction of the liquid crystal molecules in the liquid crystal capacitors when switching the polarization of the panels.

Furthermore, a method of driving a LCD is also provided for the pixel circuit of the present invention for driving a pixel to produce a corresponding frame, in order not to influence the voltages in the storage capacitors. The method is described thereinafter.

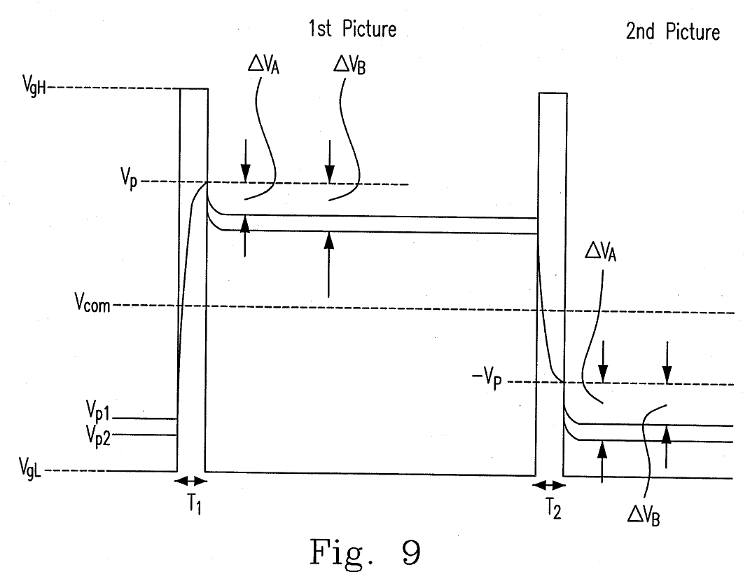

FIG. 9 shows the driving waveform diagram for driving pixel units in a preferred embodiment of the present invention. Please refer to FIG. 8 simultaneously. In a first frame of a written-in positive polarization data signal (i.e. the first data signal), the voltage of the scanning line escalates to a high level status V_{gH} in a time period T1. The first switch 8031 and the second switch 8032 are turned on. A positive polarization voltage, indicated as Vₚ, charges the first liquid crystal capacitor 8061 and the first storage capacitor 8041 via the first switch 8031, and charges the second liquid crystal capacitor 8062 and the second storage capacitor 8042 via the second switch 8032. At the end of the time period T1, the voltage of the first scanning line reduces to a low level status V_{gL}, and the first switch 8031 and the second switch 8032 are turned off. At this moment, voltages at both ends of the first liquid crystal capacitor 8061 and those of the second liquid crystal capacitor 8062 are sustained by the first storage capacitor 8041 and the second storage capacitor 8042 respectively. However, during the time period when the first switch 8031 and the second switch 8032 are turned off, the positive polarization voltage Vₚ will be reduced by a value of ΔV, wherein a magnitude of the ΔV is related to the parasitic capacitance between the gates and drains of the switches therein, the liquid crystal capacitors and the storage capacitors.

According to the first embodiment of the present invention, the first pixel 801 comprises the first sub-pixel 803 and the second sub-pixel 804. Therefore, two ΔV values, a ΔV_{A} and a ΔV_{B}, respectively make different voltage values V_{A,nm} and V_{B,mn} in the sub-pixel electrodes 8051 and 8052, wherein the value of ΔVA is related to the first parasitic capacitor 8071, the first liquid crystal capacitor 8061 and the first storage capacitor 8041. A magnitude of the feed through voltage of V_{A,nm} is described below:

ΔV_{A}=(V_{Cshigh}−V_{Cslow})*C₈₀₄₁/(C₈₀₄₁+C₈₀₆₁+C₈₀₇₁)

Or, ΔV_{A}=ΔV_{Cs}*C₈₀₄₁/(C₈₀₄₁+C₈₀₆₁+C₈₀₇₁)

wherein the value of ΔV_{B} is related to the second parasitic capacitor 8072, the second liquid crystal capacitor 8062 and the second storage capacitor 8042. A magnitude of the feed through voltage of V_{B,nm} is described below:

ΔV_{B}=(V_{Cshigh}−V_{Cslow})*C₈₀₄₂/(C₈₀₄₂+C₈₀₆₂+C₈₀₇₂)

Or, ΔV_{B}=ΔV_{Cs}*C₈₀₄₂/(C₈₀₄₂+C₈₀₆₂+C₈₀₇₂)

The difference between ΔV_{A} and ΔV_{B} can be controlled by adjusting at least one capacitance value from a group composed of a first storage capacitance C8041, a first liquid crystal capacitance C8061, and a first parasitic capacitance C8071 of the first sub-pixel 803, and a second storage capacitance C8042, a second liquid crystal capacitance C8062, and a second parasitic capacitance C8072 of the second sub-pixel 804. An ideal voltage value of each pixel on the LCD panel is achieved by adjusting a corresponding offset voltage.

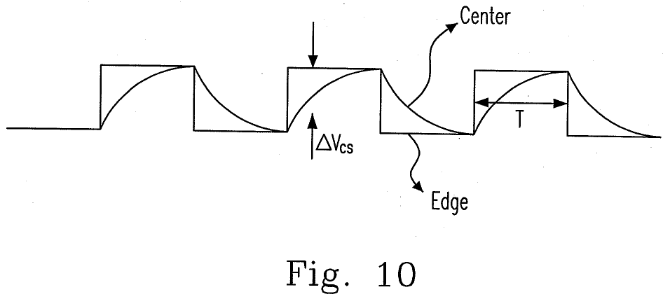

Compared with the prior art, the timing for turning on the first and the second switches is different from that for turning on the third switch, and therefore a predetermined voltage value is acquired by charging the storage capacitors via the conducting line. As shown in FIG. 10, a voltage waveform of the storage capacitors along the conducting line will not be reduced to ΔV_{Cs} due to RC-Delay, and thus the voltage variation between the central area and the edge in each pixel is trivial.

In addition, according to the equivalent circuit of the LCD pixel circuit in the present invention, for each R, G, or B pixel controlled by each scan line, a pixel comprises two thin-film transistors aligned in a first (upward) direction and an adjacent pixel thereto comprises two thin-film transistors aligned in a second (downward) direction. The two types of pixels aligned upward and downward alternatively form a layout of the entire frame. Next, a more detailed description of the data transmitted by the row-inversion driver IC (as well as the signal driver) in cooperation with the equivalent circuit of the thin-film LCD panel in the present invention as shown in FIG. 8 is illustrated as follows.

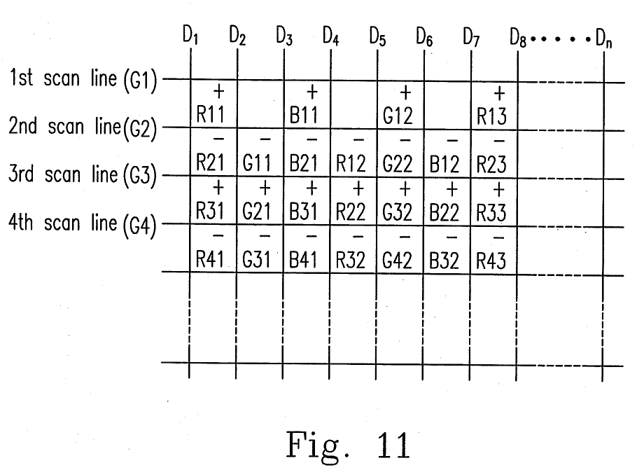

Please refer to FIG. 11, which illustrates the relationship between the data sent out from the row-inversion driver and the scanning timing of each scan line as well as the patterns of the video signals from the data lines when the method of row-inversion is engaged in driving a thin-film LCD. The data of the pixels defined by the even data lines D2, D4, D6 . . . and the scan lines G2, G3 . . . Gm are sequentially delayed for a single scanning time of the scan line. For instance, at the scanning of the second scan line, originally, the data line D2 should transfer the video data G21 of the pixel of the first display unit defined by the scan line G1 and the data line D2. However, the data line D2 transfers the video data G11 of the pixel of the first display unit defined by the scan line G1 and the data line D2. The data lines D1 and D3 still transfer the video data R21 and B21 of the pixels of the first display unit defined by the scan line G2 and the data lines D1, D3.

Likewise, the data line D4 should originally transfer the video data R22 of the pixel of the second display unit defined by the scan line G1 and the data line D4. However, the data line D4 transfers the video data R12 of the pixel of the second display unit defined by the scan line G1 and the data line D4. The data line D5 transfers the video data G22 of the pixel of the second display unit defined by the scan line G2 and the data line D5. The data line D6 transfers the video data B12 of the pixel of the second display unit defined by the scan line G2 and the data line D6.

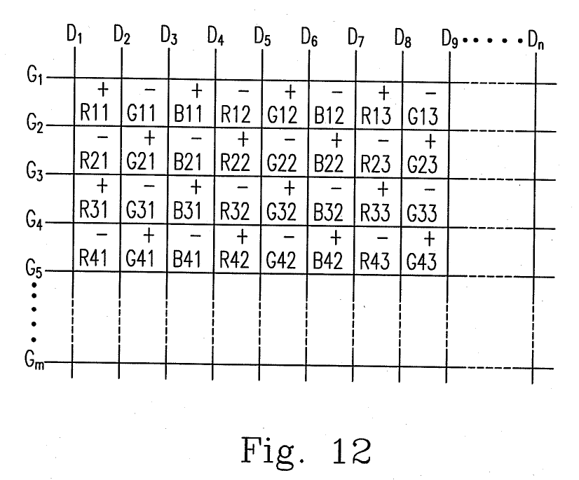

The video data as shown in FIG. 12 are driven by the row-inversion method. Accordingly, a display result of the dot-inversion driving method using a row-inversion driving method is obtained. Moreover, the changed data are input to the LCD structure of the present invention. The thin-film transistors formed at the intersections of each scan line and data line (D1, D2, D3, . . . Dn) are arranged in alternatively upward-downward form along their connected scan lines. Therefore, when the row-inversion driver is used to drive the thin-film transistor LCD device of the present invention, the data are stored in the pixel regions in an alternatively upward-downward form.

In conclusion, the present invention provides a pixel circuit and its driving method, which are applicable to liquid crystal displays and other display apparatus. An ideal voltage value of each pixel on the LCD panel is obtained by adjusting a corresponding offset voltage. The method resolves the problems of insufficient charging/discharging for the high resolution or large scale LCD panel, when operated on high frequencies. For instance, the problems of insufficient charge/discharge at 120 Hz, and the problem of failing to obtain an ideal voltage in each pixel when charged/discharged due to RC delay are resolved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display (LCD), comprising:
a first and a second scan lines and a first and a second data lines crossing each other for defining at least a first pixel having a first and a second switches and a second pixel having a third switch, wherein each of the first, the second and the third switches has a drain, a gate and a source;
a first, a second and a third storage capacitors, each of which has a first and a second electrodes, wherein the drains of each of the first, the second and the third switches are coupled to the first electrodes of the first, the second and the third storage capacitors respectively; and
a conducting line, coupled to the second electrodes of the first, the second and the third storage capacitors, wherein the gates of the first and the second switches are coupled to the first scan line, the gate of the third switch is coupled to the second scan line, the sources of the first and the second switches are coupled to the first data line, and the source of the third switch is coupled to the second data line.

2. An LCD as claimed, in claim 1, further applying a control signal to the conducting line, applying a data signal to the first data line, and the control signal and the data signal have a same frequency.

3. An LCD as claimed in claim 2, wherein the control signal is a variable voltage.

4. An LCD as claimed in claim 1, wherein the conducting line is located between the first and the second scan lines.

5. An LCD as claimed in claim 1, wherein the first and the second storage capacitors have different capacity values, and at lease one of the first and the second storage capacitors is a variable capacitor.

6. An LCD as claimed in claim 1, further comprising a common electrode and first and a second liquid crystal capacitors having a respective third electrode, wherein:
the drains of the first and the second switches are coupled to the first and the second liquid crystal capacitors respectively;
at least one selected from a group consisting of the first and the second storage capacitors and the first and the second liquid crystal capacitors has a capacity value different from those of the others; and
the third electrodes of the first and the second liquid crystal capacitors are coupled to the common electrode, which is configured to receive a common voltage signal being a constant voltage.

7. An LCD as claimed in claim 1, further comprising a first, a second and a third sub-pixel electrodes respectively coupled to the first, the second and the third storage capacitors, wherein the third switch is turned on at a different time when the first and the second switches are turned on.

8. An LCD as claimed in claim 1, wherein the first and the second switches are turned on via the first scan line, a first picture is written into the first pixel via the first data line, the third switch is turned on via the second scan line, a second picture is written into the second pixel via the second data line, and the first picture has a polarity opposite to that of the second picture.

9. An LCD as claimed in claim 1, wherein the first and the second switches are turned on via the first scan line, a data signal is transmitted to the first pixel via the first data line, and the first capacitor has a capacity value different from that of the second capacitor.

10. An LCD as claimed in claim 1, further comprising a first and a second sub-pixel electrodes coupled to the first electrodes of the first and the second storage capacitors respectively, wherein the first and the second sub-pixel electrodes have different, voltage variations by means of inputting data signals to the first and the second sub-pixel electrodes.

11. An LCD as claimed in claim 1, further comprising a first and a second sub-pixel electrodes coupled to the first electrodes of the first and the second storage capacitors respectively, wherein the first and the second switches are turned on via the first scan line, and the first and the second sub-pixel electrodes have different; voltage variations by means of inputting a data signal to the first pixel via the first data line.

12. A driving method for a liquid crystal display (LCD), wherein the LCD comprises a first pixel, a conducting line, a first and a second storage capacitors, each of which comprises a first and a second electrodes, a first and a second liquid crystal capacitors having a respective third electrode, a first scan line and a first data line, and the first pixel comprises a first and a second switches each of which has a gate and a source, the method comprising:
coupling the first and the second switches to the first electrodes of the first and the second storage capacitors respectively, and to the electrodes of the first and the second liquid crystal capacitors respectively;
coupling the second electrodes of the first and the second storage capacitors to the conducting line;
coupling the gates of the first and the second switches to the first scan line;
coupling the sources of the first and the second switches to the first data line, and at least one of the first and the second storage capacitors and the first and the second liquid crystal capacitors has a different capacity value from those of the others;
providing a first scanning signal to the first scan line to turn on the first and the second switches; and
providing a first data signal and a control signal to the first data line and the conducting line respectively, wherein the first data signal and the control signal have a same frequency.

13. The method as claimed in claim 12, wherein the LCD further comprises a first and a second sub-pixel electrodes coupled to the first electrodes of the first and the second storage capacitors respectively, the first and the second storage capacitors have different capacity values, and the control signal is a variable voltage, the method further comprising:
transmitting the first data signal to the first and the second sub-pixel electrodes for differentiating voltage variations between the first and the second sub-pixel electrodes.

14. The method as claimed in claim 12, wherein the LCD further comprises a second pixel adjacent to the first pixel, a second scan line and a second data line, and the second pixel comprises a third switch having a gate and a source coupled to the second scan line and the second data line respectively and a third storage capacitor having a first electrode coupled to the conducting line, the method further comprising:
providing a second scanning signal to the second scan line to turn on the third switch after providing the first scanning signal; and
providing a second data signal to the second data line.

15. The method as claimed in claim 14, wherein the second data signal and the control signal have a same frequency, and the first and the second data signals have opposite polarities.

16. The method as claimed in claim 14, wherein the LCD further comprises a third sub-pixel electrode, each of the first, the second and the third storage capacitors has a second electrode, and the second electrodes of the first, the second and the third storage capacitors are coupled to the first, the second and the third sub-pixel electrodes respectively, the method further comprising:
writing a first picture into the first pixel via the first data line; and
writing a second picture into the second pixel via the second data line, wherein the first and the second pictures have opposite polarities.

17. A driving method for a liquid crystal display (LCD), wherein the LCD comprises a first pixel having a first and a second switches, and each of the first and the second switches comprises a gate and a source, a conducting line, a first scan line, a first data line, a first and a second storage capacitors respectively having a first and a second electrodes, and a first and a second liquid crystal capacitors each having a third electrode, the method comprising:
coupling the first and the second switches to the first electrodes of the first and the second storage capacitors respectively, and to the third electrodes of the first and the second liquid crystal capacitors respectively;
coupling the second electrodes of the first and the second storage capacitors to the conducting line;
coupling the gates of the first and the second switches to the first scan line;
coupling the sources of the first and the second switches to the first data line, and at least one of the first and the second storage capacitors is a variable capacitor;
providing a first scanning signal to the first scan line for turning on the first and the second switches; and
providing a first data signal and a control signal to the first data line and the conducting line respectively, wherein the first data signal and the control signal have a same frequency.

18. The method as claimed in claim 17, wherein the LCD further comprises a first and a second sub-pixel electrode coupled to the first electrodes of the first and the second storage capacitors respectively, and the control signal is a variable voltage, the method further comprising:
differentiating voltage variations between the first and the second sub-pixel electrode by means of transmitting the first data signal; and
transmitting the first data signal to the first pixel for differentiating capacity values between the first and the second storage capacitors.

19. The method as claimed in claim 17, wherein the LCD further comprises a second pixel adjacent to the first pixel, a second scan line, a second data line and a third storage capacitor having an electrode coupled to the conducting line, and the second pixel comprises at least a third switch having a gate and a source, which are coupled to the second scan line and the second data line respectively, the method further comprising:
providing a second scanning signal to the second scan line for turning on the third switch after providing the first scanning signal; and
providing a second data signal to the second data line.

20. The method as claimed in claim 19, wherein the second data signal and the control signal have a same frequency, and the first and the second data signals have opposite polarities.
